(19) United States
(12) Patent Application Publication
(10) Pub. No.: US 2007/0275025 A1
(43) Pub. Date: Nov. 29, 2007

(54) Combustible Mosquito Coil or Stick

(75) Inventors: Benjamin David Hindle, Balmain (AU); Sangita Devi Kuberan, North Rocks (AU); Andrew Martin Scrivener, Canterbury (AU); Graeme Bruce Smith, Narraweena (AU); Michael Gibian, West Ryde (AU); Watson Gary Kim, Cherry Hill, NJ (US)

Correspondence Address: MERCHANT & GOULD PC, P.O. BOX 2903, MINNEAPOLIS, MN, 55402-0903, US

(73) Assignee: RECKITT BENCKISER (AUSTRALIA) PTY LIMITED, NEW SOUTH WALES (AU)

(21) Appl. No.: 10/579,122

(22) PCT Filed: Nov. 4, 2004
(86) PCT No.: PCT/GB04/04637

§ 371 Date: Jan. 24, 2007

(30) Foreign Application Priority Data
Nov. 14, 2003 (GB) 0326521.2

(51) Int. Cl. A01N 25/20; A01N 37/00; A01P 17/00; B05D 5/00

(52) U.S. Cl. 424/409; 427/299; 514/506

(57) ABSTRACT

A combustible coil or stick for controlling mosquitoes is disclosed containing an insecticidally effective amount of bifenthrin.

### FIELD OF THE INVENTION

The present invention relates to a new combustible coil or stick for controlling mosquitoes containing the pyrethroid, bifenthrin, as the active ingredient.

### BACKGROUND OF THE INVENTION

Pyrethroids were developed based on the insecticidal activity present in the pyrethrum plant extract. Early pyrethroids, like pyrethrum, were not very stable and often only resulted in the knockdown of insects, with many of them later recovering. Later, chemists developed more stable pyrethroid compounds with good kill activity and stability over several months after spraying on surfaces. In general, pyrethroids are split into two different functional groups:
i) short lived knockdown pyrethroids; and
ii) long lasting residual pyrethroids with better killing properties.

The products to which this invention relates are commonly referred to as “mosquito coils” or “incense sticks”. Such coils or sticks are characterised by being formed from a combustible material which is shaped into a circular helix or rod, respectively. Included in the combustible material are one or more active ingredients. To date, the active ingredients used in mosquito coils and sticks have been based on volatile knockdown pyrethroids (e.g. d-allethrin, transfluthrin, prallethrin, metafluthrin, esbiothrin). In general, mosquito coils and sticks comprise a coil or stick substrate, respectively, impregnated with an active ingredient. The substrate is a material which can be ignited and will slowly burn. As the product burns, the active ingredients are emanated into the atmosphere by virtue of their volatility to repel and/or knock down mosquitoes. In use, such coils and sticks will provide an effective level of the active ingredient in the atmosphere for an appropriate period of time. Typically, a coil is placed on a stand and burns over a period of two or more hours. Sticks are placed vertically in a holder which may be as simple as a bowl of sand. It is recognised that, while the use of such volatile knockdown pyrethroids results in bite inhibition and possibly even temporary knockdown, the effect is not long lasting.

In contrast, residual pyrethroids have very low volatility and to date have been used in circumstances where the mosquito comes into direct contact with a surface containing the residual pyrethroid. Typically, residual pyrethroids (e.g. permethrin, cyfluthrin, cypermethrin, deltamethrin and bifenthrin) are applied to walls of houses and impregnated in bednets to kill mosquitoes. The application of residual pyrethroids to walls and bednets has been developed in conjunction with WHO (World Health Organisation) mainly for the control of malaria mosquitoes (e.g. Anopheles gambiae). These active ingredients are applied at fairly high doses (15-500 mg/m²) and kill mosquitoes landing on walls or the bednet. In addition, most possess some degree of repellent activity so that mosquitoes may be less inclined to enter treated dwellings and to land on treated surfaces.

Although many mosquito coils and sticks are marketed for the control of mosquitoes, inferring or even claiming killing, in general consumers perceive that they only repel mosquitoes. The present inventors have verified this in numerous experimental trials wherein it has been found that although mosquitoes may be knocked down as well as repelled, these mosquitoes generally recover if removed from the smoke. Most test protocols do not necessarily look at recovery following knockdown, so a true kill action is difficult to identify. In addition, many trials are carried out in chambers with a degree of contamination to the walls due to the large number of tests conducted; levels of mortality overnight can be quite high even when no coil or stick is burnt, giving misleading results.

There clearly exists a need for a combustible coil or stick containing an active ingredient that is capable of effectively controlling and in particular killing mosquitoes.

### SUMMARY OF THE INVENTION

The present inventors have surprisingly found that a combustible coil or stick containing bifenthrin, which, as mentioned above has only been known to date as a long lasting residual pyrethroid, is effective in controlling mosquitoes. In particular, the present inventors have surprisingly found that a combustible coil or stick containing bifenthrin is capable of killing mosquitoes while the use of other known kill actives in combustible coils or sticks is ineffective in killing mosquitoes.

The present invention provides a combustible coil or stick for controlling mosquitoes comprising an insecticidally effective amount of bifenthrin, such that when combusted the bifenthrin is released from the coil or stick to control mosquitoes.

In a first aspect, the present invention is directed to a combustible coil or stick for controlling mosquitoes, the coil or stick comprising a substrate and an insecticidally effective amount of bifenthrin, wherein an oxygen supplier or accelerant is included in the coils or stick in an amount of from 0-1% w/w and the bifenthrin is present in an amount of about 0.002-0.6 % w/w, such that upon combustion of the coil or stick the bifenthrin is released at a rate of about 0.02 mg/h-12 mg/h to control mosquitoes.

In a second aspect, the present invention is directed to a combustible coil or stick for controlling mosquitoes, the coil or stick comprising an insecticidally effective amount of bifenthrin in an amount of about 0.002-0.6% w/w and a substrate that includes an oxygen supplier or accelerant in an amount of from 0-1% w/w, wherein the coil or stick is adapted to permit release of the bifenthrin from the coil or stick at a rate of about 0.02 mg/h-12 mg/h upon combustion of the coil or stick.

In a third aspect, the present invention is directed to a method for controlling mosquitoes, the method comprising burning a coil or stick according to the first and second aspect of the invention so as to allow the bifenthrin to release from the coil or stick into the atmosphere at a rate of 0.02-12 mg/h to control mosquitoes.

In a fourth aspect, the present invention is directed to a method of producing a combustible coil or stick according to the first or second aspect of the invention, the method comprising the steps of: a) providing a substrate that includes 0-1% w/w oxygen supplier or accelerant; b) combining an insecticidally effective amount of bifenthrin with the substrate; and c) shaping the substrate; wherein the substrate is shaped before or after the addition of bifenthrin.

In a fifth aspect, the present invention is directed to a method of producing a combustible stick according to the first or second aspect of the invention, the method comprising the steps of: a) providing a stick adapted to received a substrate; b) providing a substrate that includes 0-1% w/w oxygen supplier or accelerant; c) combining an insecticidally effective amount of bifenthrin with the substrate; and d) applying the substrate to the stick; wherein the substrate is applied to the stick before or after the addition of bifenthrin In a sixth aspect, the present invention is directed to use of an insecticidally effective amount of bifenthrin in a combustible coil or stick for controlling mosquitoes, wherein the coil or stick includes 0-1% w/w oxygen supplier or accelerant and 0.002-0.6% w/w of bifenthrin is impregnated within and/or coated onto the coil or stick.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated that the combustible coils or sticks of the present invention may take the form of traditional mosquito coils or incense sticks.

At this point it is worth noting that traditional mosquito coils are formed as planar circular, hexagonal or other shaped helices in a process which involves rolling or pressing a sheet of coiled dough to a uniform thickness, followed by cutting of coils and baking to remove moisture. Alternatively, moulding or other shaping processes (e.g. vacuum forming from paper pulp) could be used to give a similar final product. At the terminal end of each coil, approximately in the centre, is a small aperture which is used to locate the mosquito coil on an upstanding pin, which forms part of a stand for the coil. This stand may also form part of a dish or tray which is used to collect the ashes of the combusted coil. Once located on the stand, the coil forms a continuous spiral with the beginning of the coil, which is where combustion commences, at a point exterior to the terminal end, which sits on the locating pin. In this way the continuous spiral forms a track which combusts from the outer beginning end to the mounted terminal end.

Traditionally combustible sticks are prepared by coating a thin wooden stick in joss gum or other binding agents and rolling the stick in a combustible dry or semi-dry mix. Perfume and insecticidal active ingredient are generally introduced by dipping or spraying after the formation of the stick itself.

The method of producing a combustible stick according to the fifth aspect of the invention, defines steps a)-d). It will be understood that the step of a) providing a stick adapted to received a substrate, includes but is not limited to treating a stick, preferably a thin wooden stick, with an adhesive agent, such as gum or glue. It will be appreciated that the stick may not need to be treated in any way in order to receive a substrate. It will be understood that the step of d) applying the substrate to the stick; includes but is not limited to rolling the stick provided in step a) in a powdered substrate such that the substrate adheres to an adhesive agent on the stick; rolling thin sheets of the substrate, in dough form, around the stick; extruding or moulding the substrate, preferably in dough form, around the stick. It will be appreciated that the powder and dough substrate may be in a dry or semi-dry form. It will further be understood that bifenthrin may be added to the substrate before or after the substrate is applied to the stick.

It will be appreciated that the mosquito coils of the present invention may be formed as double or triple circular helices. In these structures, the helices are formed co-terminously. However, prior to use, each helix must be separated out. One important reason for producing coils in this way is that of economical use of available material as well as ease of formation in manufacture.

The combustible coil or stick of the present invention comprises a substrate and an insecticidally effective amount of bifenthrin. It will be appreciated that the substrate may be impregnated and/or coated with bifenthrin using known techniques.

The substrate is deemed “impregnated” with the bifenthrin if the bifenthrin is either partially or completely distributed within the material of the substrate in such a manner that the bifenthrin fills all or some of the interstices of the material of the substrate and is directly held within the substrate and supported thereby. It will be understood that impregnation of bifenthrin within the substrate includes dispersion of bifenthrin within the substrate.

The substrate is deemed to be “coated” with the bifenthrin if the bifenthrin is generally distributed directly on the surface of the substrate in such a manner that the ingredient provides a layer on the substrate and is supported thereby. It will be understood that “coating” does not preclude the possibility that a proportion of the active may be absorbed into interstices of the material of the substrate. It will also be understood that coating of the substrate with bifenthrin occurs after the substrate has been shaped. Methods of coating the coils and sticks of the invention include, but are not limited to: painting, rolling, dipping, spraying and powder coating. The active may also be applied to a coil or stick as part of an attached layer, forming a laminated structure. Such a technique is generally described in U.S. Pat. No 5,447,713.

The bifenthrin may be combined with the substrate before the coil or stick is shaped to give a coil or stick that is impregnated with bifenthrin. Alternatively, the bifenthrin may be coated and/or impregnated into the shaped coil or stick by spraying or dipping the coil or stick into a solution of bifenthrin. Preferably, the bifenthrin is combined with a suitable emulsifying agent to form an emulsified bifenthrin concentrate which is dispersed in water and then added to the coil substrate ingredients, preferably by way of spraying, during the manufacturing process.

It will be appreciated that the combustible coil or stick of the present invention may be formed using conventional mosquito coil or stick materials and techniques using bifenthrin as the insecticide. Accordingly, substrates used in conventional mosquito coils or sticks may also be utilised in the present invention.

Typically, the substrate comprises a combustible fuel material and a binding agent. It will be appreciated that the substrate may further include other additives known to be used in combustible coils and sticks. Other additives include but are not limited to emulsifying agents, accelerants or oxygen suppliers for the fuel; retardants; preservatives; colouring agents; and perfumes. As with the bifenthrin, these may be incorporated into the substrate during manufacture or applied as an external coating once the substrate has been formed.

The combustible fuel material provides the substrate with material that will easily burn and thereby allow release of the bifenthrin from the coil or stick. In particular, it allows the bifenthrin to emanate into the atmosphere through normal volatilisation caused by the heating of the substrate close to the burn front. Preferably, the combustible material is present in the coil or stick in an amount of 50-95% w/w, more preferably 75-85% w/w. Preferably, the combustible fuel material is in powdered form. Suitable combustible fuel materials include but are not limited to wood, sawdust, paper, cardboard, coconut shell, flour made from leaves and other nutshells, jute, sugarcane bagass, rice husks, tea or coffee refuse. It will be appreciated that when the combustible fuel material is formed from cardboard or other solid sheet materials which are not in powdered form, it may be cut into a planar form to the appropriate shape.

Binding agents hold the ingredients of the coil or stick together and generally consist of raw or cooked starches. Preferably, the binding agent is present in the coil or stick in an amount of 5-40% w/w, more preferably 15-30% w/w. Suitable binding agents includes but are not limited to starches such as tapioca starch, tamarind starch, tamarind kernel powder, guar gum, gum (joss) powder.

The purpose of the emulsifying agent is to promote the dispersion of the bifenthrin active throughout the aqueous medium and to ensure homogeneity. The emulsifying agent may be combined with bifenthrin before being added to the other substrate ingredients or, the emulsifying agent and bifenthrin may be added separately to the other substrate ingredients. The emulsifying agent is preferably already included in the bifenthrin concentrate in the form of a bifenthrin emulsifiable concentrate (bifenthrin EC), rather than being added separately to the coil or stick formulation. Preferably, the emulsifying agent is present in the coil or stick in an amount of 0-1 % w/w, more preferably 0.01-0.35% w/w. A range of emulsifying agent may be used in the coils and sticks of the present invention including but not limited to any one or a combination of anionic, cationic, zwitterionic, nonionic and polymeric surfactants/emulsifiers. The preferred emulsifying agent used in the present invention includes both a nonyl ethoxylate surfactant, and the surfactant dodecylbenzene sulfonate, preferably in an amount of approximately 9% w/w.

It will be understood that a bifenthrin emulsifiable concentrate (bifenthrin EC), is a concentrated solution of bifenthrin in an organic solvent that contains suitable surfactants, including emulsifiers, so that when mixed with a relatively large volume of water it will give a stable oil-in-water emulsion. It will be understood that the surfactants used in such a concentrate, function primarily in the formation of an emulsion. Known organic solvents which are suitable in forming emulsifiable concentrates may be used in the bifenthrin EC of the present invention. Known bifenthrin EC's may be used in the present invention. Preferably the emulsifiable concentrate includes a nonyl ethoxylate surfactant, and the surfactant dodecylbenzene sulfonate, more preferably in an amount of approximately 9% w/w. Examples of other suitable bifenthrin emulsifiable concentrates that may be used in the present invention are described in U.S. Pat. No 6,251,415, the contents of which are herein incorporated. Even more preferably, the bifenthrin emulsifiable concentrate is an emulsifiable concentrate containing approximately 23.34% bifenthrin. An emulsifiable concentrate containing approximately 23.34% bifenthrin is available under the trade name Biflex SFR from FMC Corporation. Preferably, the bifenthrin emulsifiable concentrate is present in the coil or stick in an amount of approximately 0.008-2.6% w/w, more preferably, approximately 0.03-1.1% w/w, even more preferably, approximately 0.09-0.43% w/w.

The oxygen supplier or accelerant acts by increasing the rate at which the substrate combusts and thereby is able to control the rate at which the bifenthrin is released from the coil or stick. In addition, the accelerant acts to prevent premature extinguishment prior to the terminal end of the coil. Preferably, the oxygen supplier or accelerant is present in the coil or stick in an amount of 0-1% w/w, more preferably 0.1-0.6% w/w. Suitable accelerants or oxygen suppliers for the fuel include but are not limited to potassium nitrate and kerosene.

The function of the retardant is to decrease the rate at which the substrate combusts and thereby is able to control the rate at which the bifenthrin is released from the coil or stick. Preferably, the retardant is present in the coil or stick in an amount of 0-5% w/w, more preferably 0.1-1% w/w. Suitable retardants include but are not limited to potassium carbonate, boric acid and talc.

The function of the preservative is to prevent the growth of mould and micro-organisms that may otherwise affect the performance or appearance of the coil or stick. Preferably, the preservative is present in the coil or stick in an amount of 0-1% w/w, more preferably, 0.1-0.5% w/w. Suitable preservatives include but are not limited to sodium benzoate and potassium sorbate.

The colouring agent enables the coil or stick to be coloured for aesthetic reasons. Preferably, the colouring agent is present in the coil or stick in an amount of 0-5% w/w, more preferably 0.1-0.5% w/w. Suitable colouring agents include but are not limited to malachite green, carmoisine red and rhodamine B.

The presence of a perfume in the coil or stick provides a consumer friendly scent when the coil is burned. Preferably, the perfume is present in the coil or stick in an amount of 0-1% w/w, more preferably 0. 1-0.5% w/w. Suitable perfumes include but are not limited to Joss powder, jasmine or other floral oils or synthetic versions thereof.

In a preferred embodiment of the invention, the materials making up the substrate are ground to powder form, combined and added to water containing the bifenthrin active as an emulsified concentrate and other materials such as dye, fragrance, binding agents and preservatives. The resultant composition is preferably pressed into a planar sheet, cut so as to form a helical shape and dried.

In one embodiment, the substrate comprises cardboard which may be a single layer or a plurality of layers or plies. Such cardboard may include bifenthrin dispersed in the cardboard during manufacture. Alternatively, the bifenthrin may be applied to the outer surfaces of the cardboard. Application would typically require the bifenthrin to be dissolved or dispersed in a liquid capable of being applied to the cardboard by a variety of techniques such as spraying and rolling so as to achieve a uniform coating on the cardboard. Conveniently, application would usually be made to one of the planar surfaces of the cardboard although both opposing outer surfaces could also be coated if required.

In the case of coils made from paper pulp, the bifenthrin could be added to the pulping liquid to then bind to the paper fibres before the water is removed by vacuum or pressure, or coated with the bifenthrin.

The coil or stick according to the present invention contains the active ingredient bifenthrin as an insecticide. Bifenthrin has the chemical name according to IUPAC and CAS as follows:
(i) IUPAC:
2-methylbiphenyl-3-ylmethyl (Z)-(1RS,3RS)-3-(2-chloro-3,3,3-trifluoroprop-1-enyl)-2,2-dimethylcyclopropanecarboxylate or
2-methylbiphenyl-3-ylmethyl (Z)-(1RS)-cis-3-(2-chloro-3,3,3-trifluoroprop-1-enyl)-2,2-dimethylcyclopropanecarboxylate; and
(ii) CAS:
(2-methyl[1,1′-biphenyl]-3-yl)methyl 3-(2-chloro-3,3,3-trifluoro-1-propenyl)-2,2-dimethylcyclopropanecarboxylate.

Bifenthrin has the chemical structure as shown below and is available from FMC Corporation, Philadelphia.

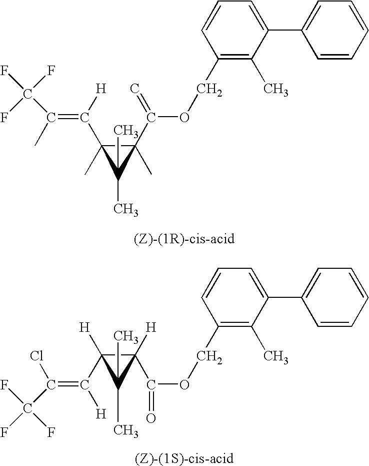

The combustible coil or stick of the present invention contains bifenthrin in an amount that is insecticidally effective. Preferably, bifenthrin is present in the combustible coil or stick of the present invention in an amount of about 0.002-0.6% w/w, more preferably, about 0.008-0.25% w/w and even most preferably, about 0.02-0.1% w/w.

Throughout the specification, the rate at which bifenthrin is released from the coil or stick of the present invention will be referred to as the release rate. The release rate of the bifenthrin from the substrate of the coil or stick into the atmosphere will be understood for practical reasons, to mean the depletion of an amount of bifenthrin from the substrate over a certain period of time whether by volatilisation (emanation) or destruction (pyrolysis) and has a unit of measurement of mg/hour. The release rate is therefore a combined measure of dose delivered into the air by emanation plus the amount pyrolysed, which in turn influences the efficacy in controlling mosquitoes. The present inventors believe that when the coil or stick according to the present invention is burned, the bifenthrin is released from the coil or stick by way of volatilisation (emanation) and to some degree pyrolysis. Without being bound by theory, the inventors believe that the flame front of a burning coil or stick generates sufficient heat so as to cause the bifenthrin to emanate from the adjacent unburnt region of the coil or stick into the atmosphere.

When the coil or stick of the present invention is combusted the bifenthrin is released from the coil or stick, preferably, at a rate in the range of about 0.02 mg/h-12 mg/h, more preferably, at a rate in the range of about 0.12 mg/h-3.75 mg/h and most preferably, at a rate in the range of about 0.3 mg/h-1.5 mg/h.

The combustible coil or stick of the present invention may be formulated so as to be effective in controlling mosquitoes for different periods of time. It will be appreciated that the amount of bifenthrin present in each coil or stick will depend on the period of time the bifenthrin is required to emanate from the burning coil or stick. For instance, for a coil or stick to be effective in controlling mosquitoes over about a 2 hour period, the coil or stick preferably has a weight in the range of approximately 2-4 g, preferably approximately 3 g, and preferably contains 0.002-0.6% w/w bifenthrin. For a coil or stick to be effective in controlling mosquitoes over about an 4 hour period, the coil or stick preferably has a weight in the range of approximately 4-8 g, preferably approximately 6 g, and preferably contains 0.002-0.6% w/w bifenthrin. For a coil or stick to be effective in controlling mosquitoes over about an 8 hour period, the coil or stick preferably has a weight in the range of approximately 8-16 g, preferably approximately 12 g, and preferably contains 0.002-0.6% w/w bifenthrin. For a coil or stick to be effective in controlling mosquitoes over about a 10 hour period, the coil or stick preferably has a weight in the range of approximately 10-20 g, preferably approximately 15 g, and preferably contains 0.002-0.6% w/w bifenthrin. For a coil or stick to be effective in controlling mosquitoes over about a 12 hour period, the coil or stick preferably has a weight in the range of approximately 12-24 g, preferably approximately 18 g, and preferably contains 0.002-0.6% w/w bifenthrin.

In a preferred embodiment, for a coil or stick to be effective in controlling mosquitoes over about a 2 hour period, the coil or stick preferably has a weight in the range of approximately 3 g and preferably contains 0.02-0.1% w/w bifenthrin; for a 4 hour period, the coil or stick preferably has a weight in the range of approximately 6 g and preferably contains 0.02-0.1% w/w bifenthrin; for an 8 hour period, the coil or stick preferably has a weight in the range of approximately 12 g and preferably contains 0.02-0.1% w/w bifenthrin; for a coil or stick to be effective in controlling mosquitoes over about a 10 hour period, the coil or stick preferably has a weight in the range of approximately 15 g and preferably contains 0.02-0.1% w/w bifenthrin; and for a coil or stick to be effective in controlling mosquitoes over about a 12 hour period, the coil or stick preferably has a weight in the range of approximately 18 g and preferably contains 0.02-0.1% w/w bifenthrin.

The combustible coil or stick according to the present invention is effective in controlling mosquitoes. It will be understood that controlling mosquitoes includes but is not limited to any one or a combination of killing, repelling or knocking down mosquitoes. It will be understood that the repellency of the coil or stick of the present invention may be measured by way of bite inhibition and/or landing inhibition. Preferably, the combustible coils and sticks of the present invention kill mosquitoes.

The present inventors have surprisingly found that the coils and sticks according to the present invention are effective in killing mosquitoes in a relatively short period of time. The coils and sticks of the present invention are effective in controlling biting mosquito pests including but not limited to Aedes aegypti and Culex quinquefasciatus. Release of bifenthrin from a coil or stick of the present invention at a rate of about 0.02-12 mg/h is effective in controlling Aedes aegypti and Culex quinquefasciatus mosquitoes after being exposed to the smoke for a period of approximately 15 minutes combustion. During this period, the mosquitoes may not necessarily be killed, or even knocked down, but will have received a lethal dose of the bifenthrin active. In a preferred embodiment of the invention, release of bifenthrin from a coil or stick of the present invention at a rate of approximately 0.75 mg/h is effective in controlling Aedes aegypti and Culex quinquefasciatus mosquitoes after approximately 15 minutes combustion. Mosquito control by bifenthrin coils consists largely of inhibiting landing and biting by mosquitoes and also delivering a lethal dose of bifenthrin to a substantial proportion of those mosquitoes.

In a preferred embodiment according to the first aspect of the invention, there is provided a combustible coil or stick for killing mosquitoes, the coil or stick comprising a substrate coated and/or impregnated with an insecticidally effective amount of bifenthrin, wherein an oxygen supplier or accelerant is included in an amount of from 0-1% w/w and the bifenthrin is present in an amount of about 0.02-0.1% w/w, more preferably about 0.05% w/w, such that upon combustion of the coil or stick the bifenthrin is released from the coil or stick at a rate of about 0.3 mg/h-1.5 mg/h, more preferably 0.75 mg/h, to kill mosquitoes.

In a more preferred embodiment according to the first aspect of the invention, there is provided a combustible coil or stick for controlling, preferably killing, mosquitoes comprising:

50-95% w/w combustible fuel material;

5-40% w/w binding agent;

0-1% w/w preservative;

0-1% w/w oxygen supplier or accelerant;

0-5% w/w retardant;

0-5% w/w colouring agent;

0-1% w/w perfume;

0-1% w/w emulsifying agent;

0.002-0.6% w/w bifenthrin.

In an even more preferred embodiment according to the first aspect of the invention, there is provided a combustible coil or stick for controlling, preferably killing, mosquitoes comprising:

35-40% w/w coconut shell;

25-50% w/w wood powder;

0.5-15% w/w gum powder;

0-20% w/w tapioca starch;

0-0.5% w/w sodium benzoate;

0-1% w/w potassium nitrate;

0-1% w/w colouring agent;

0-1% w/w perfume;

0-10% w/w guar gum;

0-20% w/w tamarind starch;

0.008-2.6% w/w bifenthrin EC (23.34% bifenthrin).

In a preferred embodiment according to the second aspect of the invention, there is provided a combustible coil or stick for killing mosquitoes, the coil or stick comprising an insecticidally effective amount of bifenthrin in an amount of about 0.02-0.1% w/w, more preferably about 0.05% w/w, and a substrate that includes an oxygen supplier or accelerant in an amount of from 0-1% w/w, wherein the coil or stick is adapted to permit release of the bifenthrin from the coil or stick at a rate of about 0.3 mg/h-1.5 mg/h, more preferably about 0.75 mg/h, upon combustion of the coil or stick.

In a preferred embodiment according to the third aspect of the invention, there is provided a method for killing mosquitoes, the method comprising burning a coil or stick according to the preferred embodiments of the first and second aspects of the invention so as to allow the bifenthrin to release from the coil or stick at a rate of 0.12-3.75 mg/h, more preferably about 0.3-1.5 mg/h, to kill mosquitoes.

In a preferred embodiment according to the fourth aspect of the invention, there is provided a method of producing a combustible coil of the present invention, the method comprising the steps of:

a) combining one or more combustible fuels, one or more binder agents and optionally one or more preservatives to form a dry mix;

b) combining an insecticidally effective amount of bifenthrin with an emulsifying agent to form an emulsified bifenthrin concentrate;

c) forming a dispersion of emulsified bifenthrin in water;

d) adding the dispersion of emulsified bifenthrin to the dry mix with mixing to form a dough;

e) shaping the dough into coils; and

f) drying the coils.

In a preferred embodiment according to the fifth aspect of the invention, there is provided a method of producing a combustible stick of the present invention, the method comprising the steps of:

a) providing a stick and optionally coating the stick with an adhesive agent, such as gum or glue;

b) providing a substrate comprising a combustible fuel material and binding agent;

c) applying the substrate to the stick by rolling the stick in the substrate; rolling thin sheets of the substrate around the stick; or extruding or moulding the substrate around the stick;

d) dipping the stick in or spraying the stick with a solution containing bifenthrin and optionally perfume.

In other preferred embodiments of the fifth aspect of the invention, the bifenthrin may be introduced by combining it directly with the adhesive agent and/or substrate.

To the limited extent that the prior art may suggest or predict the successful use of any kill active in coils or sticks to produce a coil or stick capable of killing mosquitoes, all insecticides known to be kill actives (such as d-phenothrin, bifenthrin, permethrin, cypermethrin, bioresmethrin and deltamethrin) would appear equally attractive. However, in the results discussed below, the present inventors have surprisingly found that in fact, with the exception of bifenthrin, the examples of the actives tested were not sufficiently effective to be employed as kill actives in coils that were combusted and resulted in emanation of the active into the atmosphere. In particular, deltamethrin, a very active kill agent with high residuality showed low mortality (12% after 15 min exposure) when used in a coil at an active level (0.07%) which was cost comparable with d-allethrin, an existing coil active.

As compared to mosquito coils or sticks based on kill active ingredients other than bifenthrin, the coils or sticks of the present invention are cost effective, have superior kill ability and are efficacious after a relatively short period of exposure.

### MODES FOR CARRYING OUT THE INVENTION

In order to understand better the nature of the invention, a number of Examples will now be described.

### EXAMPLE 1

### Calculation of Emanation Rate

A combustible coil (12 g) according to the invention containing about 0.05% w/w bifenthrin was combusted for a period of 8 hours. After 8 hours, the release rate of the active, bifenthrin, from the coil was calculated as follows:

$$\begin{matrix}Release rate of active = ( mass of coil burnt after 8 hours ) \times \\ ( \% active ingredient in the coil ) / coil burn time \\ = ( 12 , 000 mg \text{/} h ) \times ( 0.05 \% w \text{/} w ) / 8 hrs \\ = 0.75 mg \text{/} h\end{matrix}$$

### EXAMPLES 2-6

Examples of formulations of combustible coils according to the present invention are shown in Table 1.

TABLE 1
Combustible coil or stick formulations

| | Example 2 | Example 3 | Example 4 | Example 5 | Example 6 |
|---|---|---|---|---|---|
| | (0.1% w/w | (0.05% w/w | (0.02% w/w | (0.05% w/w | (0.05% w/w |
| | bifenthrin) | bifenthrin) | bifenthrin) | bifenthrin) | bifenthrin) |
| Ingredient | % w/w | % w/w | % w/w | % w/w | % w/w |
| Coconut Shell Powder TR | 39.012 | 39.097 | 39.148 | 38.078 | 37.073 |
| Wood Powder TR | 28.743 | 28.806 | 28.843 | 44.184 | 45.345 |
| Gum (Joss) Powder TR | 12.976 | 13.004 | 13.021 | 1.29 | 1.280 |
| Tapioca Starch TR | 17.91 | 17.949 | 17.972 | — | — |
| Sodium Benzoate | 0.4 | 0.4 | 0.4 | 0.301 | 0.181 |
| Potassium Nitrate TR | 0.13 | 0.13 | 0.13 | 0.525 | 0.522 |
| Malachite Green | 0.18 | 0.18 | 0.18 | 0.313 | 0.201 |
| Perfume (TIGA 164381D) | 0.22 | 0.22 | 0.22 | 0.4 | 0.414 |
| Guar Gum | — | — | — | 4.028 | 4.923 |
| Tamarind Starch | — | — | — | 10.037 | 9.847 |
| Bifenthrin EC (23.34% | 0.429 | 0.214 | 0.086 | 0.214 | 0.214 |
| bifenthrin) | | | | | |

Product Availability:

| Ingredient | Supplier/Source |
|---|---|
| Coconut Shell Powder TR | P.T Sinar Plataco Cibitung |
| Wood Powder TR | P.T Sinar Plataco Cibitung |
| Gum (Joss) Powder TR | P.T Karya Prima |
| Tapioca Starch TR | P.T Sinar Jaya Makmur |
| Sodium Benzoate | P.T Justus Kimia Raya |
| Potassium Nitrate TR | P.T. Lautan Luas TBK |
| Malachite Green | P.T. Lautan Luas Pewarna |
| Perfume (TIGA 164381D | P.T Firmenich |
| Guar Gum | Kolety Gum Industries |
| Tamarind Starch | Chetna Enterprises |
| Bifenthrin EC (23.34% | FMC Corporation |
| bifenthrin)* | |

*EC indicates emulsifiable concentrate

Combustible coils of the present invention were made using the above formulations. The following methodology was employed in making these coils:

Dry powdered coconut and wood material making up the substrate were mixed together to form a dry mix in a kneading apparatus. Starches that did not require heating in order to act effectively as binding agents (such as tamarind starch) were added to the dry mix at this stage. Starches (such as tapioca starch) that did require heating were mixed separately in hot water (approximately 96° C.-100° C.) with sodium benzoate and potassium nitrate prior to addition to the dry mix. Bifenthrin was either combined with a suitable emulsifying agent to form an emulsifiable concentrate of bifenthrin or preferably, obtained as a prepared emulsifiable concentrate. A dye was mixed separately in hot water, cooled then added to the bifenthrin-emulsified concentrate, along with any fragrance. This was then introduced to the material in the kneading apparatus via a spray arm while the material was being worked to give a homogeneous dough. The dough was extruded as a flat sheet and stamped into coils which were then dried in an oven.

### EXAMPLE 7

### Effectiveness of Combustible Coil of Present Invention

A combustible coil according to the present invention containing bifenthrin was compared with coils containing other pyrethroid active ingredients (d-allethrin, d-phenothrin, imiprothrin, permethrin, cypermethrin, bioresmethrin, deltamethrin) as indicated in Table 2. All coils contained active ingredients in an amount that rendered them similar in cost to the current leading d-allethrin coils. The range of actives covered both knockdown and residual pyrethroids. The trial was carried out against the Dengue mosquito (Aedes aegypti). The methodology employed is as follows:

The study was conducted in a ventilated test chamber (20 cubic metres) at a temperature of between 27° C. and 28.7° C. The relative humidity was ambient and ranged from 51% to 58%.

Mixed sex adult 6 to 10 day old Dengue mosquitoes (Aedes aegypti) were used in this study. There were 50 female mosquitoes released per replicate and a variable number of male mosquitoes. The mosquitoes were collected and immobilised. Male and female mosquitoes were added to a container until 50 female mosquitoes were obtained. Because only female mosquitoes bite human subjects, the number of males present in each trial was irrelevant. The mosquitoes were allowed to recover for at least one hour before being used for testing.

A positive air flow of 0.4 metres/second was generated into the chamber and air was passively vented from the chamber.

Coil treatments were placed on the floor in the test chamber, and were allowed to burn for 5 minutes before all mosquitoes were brought into the chamber and released. The coils continued to operate during the assessments and were stopped at the completion of the test period.

Starting from 10 minutes after the mosquitoes were released, an assessment was made by one human subject of the mosquito landings and bites over a 5 minute period. Whilst seated in the chamber, the subject recorded the total number of females that initiated a bite on the subject's legs, as well as the number of females that landed without initiating biting. Mosquitoes were permitted to probe the subject but not permitted to bite the subject, and were chased away prior to this occurring.

Immediately after the 5 minute assessment period, the number of knocked down mosquitoes was recorded. All the mosquitoes were collected and removed from the chamber. After 24 hours, the number of dead mosquitoes was recorded. The same human subject was used for all assessments.

The results shown in the Table 2 are the means of four trials.

Table 2 shows percentage landing inhibition, percentage bite inhibition, percentage knockdown and percentage mortality for each coil used in the trial after 15 minutes exposure of the Aedes aegypti mosquitoes to each burning coil treatment.

Percentage landing inhibition refers to the number of mosquitoes which landed on the subject in the absence of any treatment (untreated control), minus the number of mosquitoes which landed on the subject in the presence of a coil treatment, divided by the number of mosquitoes which landed on the subject in the absence of any treatment, expressed as a percentage. Landing inhibition was assessed from 10 to 15 minutes exposure of the Aedes aegypti mosquitoes to each burning coil treatment.

Percentage bite inhibition refers to the number of mosquitoes which probed or attempted to bite the subject in the absence of any treatment (untreated control), minus the number of mosquitoes which attempted to bite the subject in the presence of a coil treatment, divided by the number of mosquitoes which attempted to bite the subject in the absence of any treatment, expressed as a percentage. It will be appreciated that, as mosquitoes must first land before attempting to bite, of necessity, percentage bite inhibition will always be lower than or equal to percentage landing inhibition. Bite inhibition was assessed from 10 to 15 minutes exposure of the Aedes aegypti mosquitoes to each burning coil treatment.

Knockdown refers to mosquitoes present on the floor of the chamber after the 15 minute trial, which were either dead, moribund, or incapacitated (i.e. unable to fly off the floor of the chamber). Percentage knockdown refers to the number of knocked down mosquitoes on the floor of the chamber after 15 minutes, divided by the total number of mosquitoes present in the chamber, expressed as a percentage.

Kill refers to the state of mosquitoes which 24 hours post-treatment were dead or completely non-responsive to prodding. Percentage kill refers to the number of dead mosquitoes 24 hours post treatment, divided by the total number of mosquitoes collected from the chamber, expressed as a percentage.

The trial against the Dengue mosquito (Aedes aegypti) showed that only one pyrethroid, bifenthrin, demonstrated any significant kill action (94% after 15 min exposure). There was no pattern between the residual versus knockdown pyrethroids which could have indicated to the inventors that bifenthrin would have performed so effectively. In fact, the results shown in Table 2 were somewhat counter-intuitive given that deltamethrin, a highly efficacious kill agent with high residuality showed low mortality (12% after 15 min exposure) when used in a coil. It was therefore surprising to the inventors that bifenthrin gave excellent kill performance in coils, while other kill actives were ineffective.

The above results show that that bifenthrin is the only pyrethroid that offers significant kill following a short exposure to the active emanated from a coil. This was not predictable from the information at hand as other residual pyrethroids with documented kill action failed to show sufficient kill action when put into a coil.

### EXAMPLE 8

### Dose Response

The trial detailed in Example 2 was repeated against Aedes aegypti, using identical methodology, but comparing a range of bifenthrin active levels (0.02%, 0.05% and 0.1%) against d-allethrin. Percentage landing inhibition, percentage bite inhibition, percentage knockdown and percentage mortality are as defined above. As detailed in Table 3, these data revealed a dose-response effect, where percentage landing inhibition, bite inhibition and kill increased with increasing bifenthrin levels in the coils. Again, these data revealed the extremely poor kill performance of d-allethrin which was no different from the untreated control.

### EXAMPLE 9

### Efficacy of Combustible Coils of the Present Invention Against Culex quinquefasciatus

The trial detailed in Example 2 was repeated against the much more difficult to kill Culex quinquefasciatus mosquitoes. The methodology used was similar to that employed for Aedes aegypti described above, with the following variations.

One hundred female and a variable number of male Cx. quinquefasciatus were confined in a small cage which was placed in the chamber 5 minutes after the coil treatment had been ignited. For this species of mosquito, the subject's arm was inserted into the cage for determinations of landing and biting rates. The reasons for these changes in methodology compared to those used for Ae. aegypti was because Cx. quinquefasciatus are much weaker biters. This meant that satisfactory biting rates could only be achieved by confining them to a small volume. The results are shown in Table 4.

Percentage landing inhibition, percentage bite inhibition, percentage knockdown and percentage mortality are as defined above. The results in Table 4 show that bifenthrin demonstrated superior kill action (27% at 0.05% after 15 minutes exposure) in comparison to the conventional d-allethrin coil (2% at 0.25% after 15 minutes exposure, being equivalent to the untreated control) but not to the same high level as against the Ae. aegypti mosquito. As Cx. quinquefasciatus is a more robust mosquito species the lower level of mortality after 15 minutes exposure when compared with the Ae. aegypti mosquitoes was expected.

These results also show that 0.05% bifenthrin coils were more effective than 0.02% bifenthrin coils in killing and knocking down both Ae. aegypti and Cx. quinquefasciatus mosquitoes after 15 minutes exposure to the burning coil. There was very little change in the effectiveness of a 0.1% bifenthrin coil when compared with a 0.05% bifenthrin coil in knocking down and killing Ae. aegypti mosquitoes after 15 minutes exposure to the burning coil, the 0.1% bifenthrin coil being slightly more effective than the 0.05% bifenthrin coil for the Cx. quinquefasciatus mosquito. It should be noted that while the 0.05% bifenthrin coil is approximately at cost parity with the commercially available 0.25% d-allethrin coil, it is surprisingly much more effective at killing mosquitoes after 15 minutes exposure.

### EXAMPLE 10

### Comparison of Physical Properties of Bifenthrin with Other Residual Pyrethroids

The present inventors compared some physical properties of bifenthrin with those of other residual pyrethroids. These are summarised in Table 5.

These results support the surprising nature of the discovery of the killing efficacy of bifenthrin in the combustible coil of the present invention. By way of comparison, d-phenothrin had a similar vapour pressure to bifenthrin, but, at 4.5 times the level of bifenthrin (0.228% vs. 0.05%, respectively), it gave only 24% kill performance against Aedes aegypti compared to 94% for bifenthrin. Similarly, bioresmethrin had 775 times the vapour pressure of bifenthrin, but, at a similar coil active level (0.056% vs. 0.05% for bifenthrin), gave only 23% kill efficacy against Aedes aegypti.

The inventors have shown that the unexpected efficacy of bifenthrin over other residual pyrethroids could not be predicted from its physical characteristics.

TABLE 2
% landing inhibition, % bite inhibition, % KD (knock down) and
% 24 hour mortality of Aedes aegypti mosquitoes after 15 minutes
exposure to burning coils containing a range of pyrethroids

| | | | | | 24 hour % |
|---|---|---|---|---|---|
| | | | | | mortality |
| | | % landing | % bite | % KD | (15 mins |
| | | inhibition | inhibition | (15 mins) | exposure) |
| 0.25% | d-Allethrin | 98 | 100 | 35 | 7 |
| 0.05% | Bifenthrin | 87 | 99 | 31 | 94 |
| 0.228% | d-Phenothrin | 98 | 100 | 39 | 24 |
| 0.035% | Imiprothrin | 34 | 34 | 1 | 7 |
| 0.705% | Permethrin | 8 | 85 | 35 | 55 |
| 0.3% | Cypermethrin | 70 | 73 | 10 | 56 |
| 0.056% | Bioresmethrin | 96 | 99 | 41 | 23 |
| 0.07% | Deltamethrin | 57 | 57 | 0 | 12 |

| | | | | |
|---|---|---|---|---|
| Blank coil | 31 | 22 | 1 | 6 |
| Untreated control | — | — | 0 | 10 |

TABLE 3
% landing inhibition, % bite inhibition, % KD (knock
down) and % 24 hour mortality of Aedes aegypti mosquitoes
after 15 minutes exposure to burning coils containing
a range of actives at varying doses

| | | | | | 24 hour % |
|---|---|---|---|---|---|
| | | | | | mortality |
| | | % landing | % bite | % KD | (15 mins |
| | | inhibition | inhibition | (15 mins) | exposure) |
| 0.02% | Bifenthrin | 80 | 95 | 15 | 78 |
| 0.05 | Bifenthrin | 87 | 99 | 31 | 94 |
| 0.10% | Bifenthrin | 92 | 100 | 30 | 96 |
| 0.25% | d-Allethrin | 98 | 100 | 35 | 7 |

| | | | | |
|---|---|---|---|---|
| Blank coil | 31 | 33 | 1 | 6 |
| Untreated control | 0 | 0 | 6 | 9 |

TABLE 4
% landing inhibition, % bite inhibition, % KD (knock
down) and % 24 hour mortality of Culex quinquefasciatus
mosquitoes after 15 minutes exposure to burning coils
containing a range of actives at varying doses

| | | | | | 24 hour % |
|---|---|---|---|---|---|
| | | | | | mortality |
| | | % landing | % bite | % KD | (15 mins |
| | | inhibition | inhibition | (15 mins) | exposure) |
| 0.02% | Bifenthrin | 86 | 96 | 1 | 9 |
| 0.05 | Bifenthrin | 85 | 95 | 3 | 27 |
| 0.10% | Bifenthrin | 86 | 99 | 4 | 39 |
| 0.25% | d-Allethrin | 87 | 94 | 7 | 2 |

| | | | | |
|---|---|---|---|---|
| Blank coil | −22 | −22 | 0 | 3 |
| Untreated control | 0 | 0 | 0 | 2 |

TABLE 5
Comparison of physical properties of bifenthrin with other pyrethroids

| | | | | | | % mortality of |
|---|---|---|---|---|---|---|
| | Vapour | | Melting | Boiling | | Ae. aegypti |
| | Pressure | | Point | Point | Molecular | (15 mins |
| | (mPa) | | (° C.) | (° C.) | Weight | exposure) |
| 0.25% d-Allethrin | 0.16 | (21° C.) | — | 281.5 | 302.4 | 7 |
| 0.05% Bifenthrin | 0.024 | (25° C.) | 68-70.6 | Decomp >170 | 422.9 | 94 |
| 0.228% d-Phenothrin | 0.019 | (21.4° C.) | — | >290 | 350.5 | 24 |
| 0.035% Imiprothrin | 0.0018 | (25° C.) | — | — | 318.4 | 7 |
| 0.705% Permethrin | 0.0025 | (20° C.) | 34-35 | 200 | 391.3 | 55 |
| 0.3% Cypermethrin | 0.0002 | (20° C.) | 61-83 | — | 416.3 | 56 |
| 0.056% Bioresmethrin | 18.6 | (25° C.) | 32 | Decomp >180 | 338.4 | 23 |
| 0.07% Deltamethrin | 0.0000124 | (25° C.) | 100-102 | — | 505.2 | 12 |
| Blank coil | | | | | | 6 |
| Untreated control | | | | | | 10 |

(Source of date relating to vapour pressure, melting point, boiling point and molecular weight: The Pesticide Manual, A World Compendium. 12th Ed. Editor C. D. S. Tomlin. British Crop Protection Council. The data relating to mortality is experimental data prepared by the inventors.)

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A solid combustible means for controlling mosquitoes, consisting essentially of a substrate, an insecticidally effective amount of bifenthrin, and an accelerant wherein bifenthrin is present in an amount of about 0.002-0.6% w/w, such that upon combustion bifenthrin is released at a rate of about 0.02 mg/h -12 mg/h to control mosquitoes.

2. The means of claim 1 wherein bifenthrin is in an amount of about 0.002-0.6% w/w and the accelerant is in an amount of from 0-1% w/w.

3. The means of claim 1 wherein the mosquitoes are controlled by killing.

4. The means of claim 2 wherein the bifenthrin is released at a rate of about 0.12 mg/h-3.75 mg/h.

5. The means of claim 2 wherein the bifenthrin is released at a rate of about 0.3 mg/h-1.5 mg/h.

6. The means of claim 2 wherein the bifenthrin is present in an amount of about 0.008-0.25% w/w.

7. The means of claim 2 wherein the bifenthrin is present in an amount of about 0.02-0.1% w/w.

8. The means of claim 2 wherein the means has a weight of approximately 2-4 g.

9. The means of claim 2 wherein the means has a weight of approximately 4-8 g.

10. The means of claim 2 wherein the means has a weight of approximately 8-16 g.

11. The means of claim 2 wherein the means has a weight of approximately 10-20 g.

12. The means of claim 2 wherein the means has a weight of approximately 12-24 g.

13. A solid combustible stick means for killing mosquitoes consisting essentially of a substrate, about 0.02-0.1% w/w of bifenthrin, and 0-1% w/w of accelerant such that upon combustion of the means the bifenthrin is released at a rate of about 0.3 mg/h-1.5 mg/h to kill mosquitoes.

14. A solid combustible means for killing mosquitoes, consisting essentially of a substrate, about 0.02-0.1% w/w of bifenthrin and 0-1% w/w of accelerant wherein the means is adapted to permit release of the bifenthrin at a rate of about 0.3-1.5 mg/h upon combustion of the coil or stick.

15. The means of claim 14 wherein the substrate comprises a combustible fuel and a binder agent.

16. The means of claim 15 wherein the combustible fuel is selected from group consisting of wood, sawdust, cardboard, coconut shell, leaves, nutshells, jute, sugarcane bagass, rice husks, tea refuse coffee refuse or mixtures thereof.

17. The means of claim 15 wherein the binder agent is selected from one or more of the group consisting of starch, tamarind starch, tamarind kernal powder, guar gum, gum (joss) powder or mixtures thereof.

18. The means of claim 15 wherein the substrate further comprises an additive selected from the group consisting of an emulsifying agent, a retardant, a preservative, a colouring agent, a perfume and mixtures thereof.

19. A solid combustible means for controlling mosquitoes consisting of:
50-95% w/w combustible fuel material;
5-40% w/w binding agent;
0-1% w/w preservative;
0-1% w/w accelerant;
0-5% w/w retardant;
0-5% w/w colouring agent;
0-1% w/w perfume;
0-1% w/w emulsifying agent;
0.002-0.6% w/w bifenthrin.

20. A solid combustible means for controlling mosquitoes consisting of:
35-40% w/w coconut shell;
25-50% w/w wood powder;
0.5-15% w/w gum (joss) powder;
0-20% w/w tapioca starch;
0-0.5% w/w sodium benzoate;
0-1% w/w potassium nitrate;
0-1% w/w colouring agent;
0-1% w/w perfume;
0-10% w/w guar gum;
0-20% w/w tamarind starch;
0.008-2.6% w/w bifenthrin EC (23.34% active bifenthrin).

21. A method for controlling mosquitoes, the method comprising burning a control means of claim 2 so as to allow the bifenthrin to release into the atmosphere at a rate of 0.02 mg/h-12 mg/h.

22. The method according to claim 21 wherein the bifenthrin releases at a rate of about 0.12 mg/h-3.75 mg/h.

23. The method according to claim 21 wherein the bifenthrin releases at a rate of about 0.3 mg/h-1.5 mg/h.

24. A method of producing a combustible control means of claim 1, the method comprising the steps of: a) combining a substrate that includes 0-1% w/w accelerant with an insecticidally effective amount of bifenthrin; and b) shaping the substrate; wherein the substrate is shaped before or after the addition of bifenthrin.

25. The method of claim 24 wherein the method comprises the steps of:
a) combining one or more combustible fuels, one or more binder agents and optionally one or more preservatives to form a dry mix;
b) combining an insecticidally effective amount of bifenthrin with an emulsifying agent to form an emulsified bifenthrin concentrate;
c) forming a dispersion of emulsified bifenthrin in water;
d) adding the dispersion of emulsified bifenthrin to the dry mix with mixing to form a dough;
e) shaping the dough to form a shaped dough; and
f) drying the shaped dough.

26. A method of producing a combustible control means of claim 1, the method comprising the steps of: a) a stick adapted to received a substrate with a substrate that includes 0-1% w/w accelerant to form an assembly; b) combining an insecticidally effective amount of bifenthrin with the stick or substrate wherein the substrate is applied to the stick before or after the addition of bifenthrin.

27. The method according to claim 26, the method comprising the steps of:
a) providing a stick and optionally coating the stick with an adhesive agent;
b) providing a substrate comprising a combustible fuel material and binding agent;
c) combining the substrate with stick by rolling the stick in the substrate; rolling thin sheets of the substrate around the stick; or extruding or moulding the substrate around the stick; and
d) combining the stick with a solution containing bifenthrin.

28. The method according to claim 27 wherein the adhesive agent is gum or glue.

29. The method of claim 24 wherein the bifenthrin is present in an amount of about 0.008-0.25% w/w.

30. The method of claim 24 wherein the bifenthrin is present in an amount of about 0.02-0.1% w/w.

31. The combustable means of claim 1, comprising a stick.

32. The combustable means of claim 1, comprising a coiled stick.

33. The combustable means of claim 1 wherein the accelerant is an oxygen supplier.
